(19) United States
(12) Patent Application Publication
(10) Pub. No.: US 2026/0079782 A1
(43) Pub. Date: Mar. 19, 2026

(54) ACCURACY OF RESULTS OBTAINED FROM USE OF A GENERATIVE ARTIFICIAL INTELLIGENCE (GAI) MODEL

(71) Applicant: INTERNATIONAL BUSINESS MACHINES CORPORATION, ARMONK, NY (US)

(72) Inventors: Manish Anand Bhide, Hyderabad (IN); PRATAP KISHORE VARMA VEMULAMANDA, HYDERABAD (IN); Ravi Chandra Chamarthy, Hyderabad (IN); Madhavi Katari, Hyderabad (IN)

(21) Appl. No.: 18/889,523

(22) Filed: Sep. 19, 2024

(51) Int. Cl. G06F 11/07

(52) U.S. Cl. CPC G06F 11/079

(57) ABSTRACT

A method, computer program product, and computer system for improving accuracy of results obtained from use of a generative artificial intelligence (GAI) model. The GAI model is executed to generate Q answers to Q questions Q prompts, respectively. A c-score is computed for each c-metric of multiple c-metrics of the Q questions. The computed c-score exceeds zero for X c-metrics of the multiple c-metrics. X Retrieval-Augmented Generation (RAG) shapes respectively corresponding to the X c-metrics are generated. Multiple RAG shape multiplets and associated multiplet scores are determined using the X RAG shapes. A top RAG shape multiplet having a highest RAG multiplet score is selected from the multiple RAG shape multiplets. The top RAG shape multiplet is graphically displayed on a display device. The GAI model's accuracy is improved after a root cause of the GAI model's inaccuracy was identified from the graphically displayed top RAG shape multiplet.

### BACKGROUND

The present invention relates to Retrieval-Augmented Generation (RAG), and more specifically to improvement, through use of RAG, of accuracy of results obtained from use of a generative artificial intelligence (GAI) model.

### SUMMARY

Embodiments of the present invention provide a method, a computer program product, and a computer system, for improving accuracy of results obtained from use of a generative artificial intelligence (GAI) model. One or more processors of a computer system execute the GAI model, using Q contexts in Q prompts inputted to the GAI model, to generate Q answers to Q questions in the Q prompts, respectively, wherein the Q contexts are outside of a scope of training data used to train the GAI model, and wherein Q is at least 2. The one or more processors compute, using the Q answers and the Q contexts, a c-score for each c-metric of multiple c-metrics of the Q questions, wherein the computed c-score exceeds zero for X c-metrics of the multiple c-metrics, wherein X is at least 4, and wherein X exceeding zero indicates an inaccuracy in the generated Q answers. The one or more processors generate X Retrieval-Augmented Generation (RAG) shapes respectively corresponding to the X c-metrics, wherein each RAG shape's area is proportional to each RAG shape's c-score. The one or more processors determine, using the X RAG shapes, multiple RAG shape multiplets and associated multiplet scores, wherein each RAG shape multiplet is a RAG shape doublet or a RAG shape triplet. The one or more processors select, from the multiple RAG shape multiplets, a top RAG shape multiplet having a highest RAG multiplet score, the top RAG shape multiplet being a RAG shape triplet or a RAG shape doublet. The one or more processors graphically display, on a display device of a computing device accessible to a user, the top RAG shape multiplet. The one or more processors improve the GAI model's accuracy after a root cause of the GAI model's inaccuracy was identified from the graphically displayed top RAG shape multiplet.

### BRIEF DESCRIPTION OF THE DRAWINGS

FIGS. 1A, 1B, and 1C depict a Retrieval-Augmented Generation (RAG) procedure for using a foundation model to answer questions, in accordance with embodiments of the present invention.

FIGS. 2A, 2B and 2C depict exemplary overlapping RAG shapes, in accordance with embodiments of the present invention.

FIG. 3 is a flow chart of a method for improving accuracy of results obtained from use of a generative artificial intelligence (GAI) model, in accordance with embodiments of the present invention.

FIG. 4 is a flow chart of a process for executing an improvement in the GAI model's accuracy, in accordance with embodiments of the present invention

FIG. 5 is a flow chart of a process for generating multiple RAG shapes respectively corresponding to multiple c-metrics, in accordance with embodiments of the present invention.

FIG. 6 illustrates a computer system, in accordance with embodiments of the present invention.

FIG. 7 depicts a computing environment which contains an example of an environment for the execution of at least some of the computer code involved in performing the inventive methods, in accordance with embodiments of the present invention.

### DETAILED DESCRIPTION

According to an aspect of the invention, accuracy of results obtained from use of a generative artificial intelligence (GAI) model is improved. One or more processors of a computer system execute the GAI model, using Q contexts in Q prompts inputted to the GAI model, to generate Q answers to Q questions in the Q prompts, respectively, wherein the Q contexts are outside of a scope of training data used to train the GAI model, and wherein Q is at least 2. The one or more processors compute, using the Q answers and the Q contexts, a c-score for each c-metric of multiple c-metrics of the Q questions, wherein the computed c-score exceeds zero for X c-metrics of the multiple c-metrics, wherein X is at least 4, and wherein X exceeding zero indicates an inaccuracy in the generated Q answers. The one or more processors generate X Retrieval-Augmented Generation (RAG) shapes respectively corresponding to the X c-metrics, wherein each RAG shape's area is proportional to each RAG shape's c-score. The one or more processors determine, using the X RAG shapes, multiple RAG shape multiplets and associated multiplet scores, wherein each RAG shape multiplet is a RAG shape doublet or a RAG shape triplet. The one or more processors select, from the multiple RAG shape multiplets, a top RAG shape multiplet having a highest RAG multiplet score, the top RAG shape multiplet being a RAG shape triplet or a RAG shape doublet. The one or more processors graphically display, on a display device of a computing device accessible to a user, the top RAG shape multiplet. The one or more processors improve the GAI model's accuracy after a root cause of the GAI model's inaccuracy was identified from the graphically displayed top RAG shape multiplet.

The preceding aspect of the invention provides a technical feature of RAG shape doublets and triplets that include multiple overlapping metrics and are advantageously used to identify a root cause of inaccuracy in answers generated by the GAI model, which is not possible by merely analyzing individual metrics.

According to one embodiment, improving the GAI model's accuracy includes: in response to said graphically displaying the top RAG shape multiplet to the display device of the computing device, receiving from the computing device an identification of a root cause of the inaccuracy in the generated Q answers, wherein the identification of the root cause was based on the graphically displayed top RAG shape multiplet; removing the root cause whose identification was based on the graphically displayed top RAG shape multiplet; executing, using the Q contexts in the Q prompts, the GAI model to generate Q answers to the Q questions, respectively; and computing, using the Q answers and the Q prompts, a c-score for each c-metric of multiple c-metrics of the Q question, wherein the computed c-score exceeds zero for Y c-metrics of the multiple c-metrics, and wherein Y<X which indicates an improvement in accuracy of the GAI model.

The preceding one embodiment provides technical features of (i) removing the root cause of the GAI model's inaccuracy to improve the GAI model's accuracy and (ii) executing the GAI model with the root cause removed to confirm that the GAI model's accuracy has been improved, by confirming that the number of c-metrics associated with inaccurate c-metric scores has been reduced.

According to one embodiment, determining multiple RAG shape multiplets and associated multiplet scores includes: sorting the X c-metrics in descending order of c-score and retaining, from the sorted X c-metrics, K1 c-metrics having the K1 highest c-scores, wherein K1 is at least 3; sorting c-metric pairs formed from the K1 c-metrics in descending order of overlap area and retaining, from the sorted c-metric pairs, K2 c-metric pairs having the K2 highest overlap areas, wherein K2 is at least 2, wherein each c-metric pair is a RAG shape doublet, and wherein the overlap area of each c-metric pair is a doublet score; and designating the c-metric pair having the highest doublet score as the top RAG shape multiplet; adding, to each c-metric pair of the K2 c-metric pairs, a c-metric of the K1 c-metrics for all c-metrics of the K1 c-metrics that are not a c-metric of the c-metric pair, which forms multiple RAG shape triplets; calculating a triplet score for each RAG shape triplet of the multiple RAG shape triplets; and designating, from the multiple RAG shape triplets, the RAG shape triplet having the highest triplet score as the top RAG shape multiplet if the highest triplet score exceeds the highest doublet score.

The preceding one embodiment provides technical features of efficiently determining the top RAG shape multiplet (to be subsequently used to find a root cause of the GAI model's inaccuracy), by sequentially determining the K1 top c-metrics, the K2 top c-metric pairs, and the top RAG shape triplet, which avoids hours, days or weeks that would have otherwise been required in an effort unlikely to find the root cause.

According to one embodiment, the c-metric pairs formed from the K1 c-metrics include a naturally correlated c-metric pair, wherein prior to sorting the c-metric pairs formed from the K1 c-metrics, the method includes: deleting, by the one or more processors, the naturally correlated c-metric pair from the c-metric pairs formed from the K1 c-metrics.

The preceding one embodiment provides a technical feature of deleting the naturally correlated c-metric pair, which improves the method's efficiency, since the naturally correlated c-metric pair cannot contribute to finding the root cause.

According to one embodiment, the top RAG shape multiplet is a RAG shape triplet or a RAG shape doublet.

The preceding one embodiment provide a technical feature of limiting the overlapping RAG shapes to 2 or 3 overlapping RAG shapes, which avoids a much more complex and cumbersome analysis that would be required to find the root cause if 4 or more overlapping RAG shapes were used.

Generative artificial intelligence (GAI) is artificial intelligence (AI) that creates text responses based on large language models (LLMs), where the GAI is trained on a large number of data points. The GAI receives input prompts, which are questions to answer, and provides answers to the questions.

A limitation in the utility of GAI is that the ability of GAI to provide timely responses is limited to the training data used to train the GAI and such training data may be weeks, months, or years out of date. Thus, a correct response to a prompt may require the GAI model to have access to information that is beyond the scope of the training data, which can lead to incorrect responses that reduce confidence in the accuracy of the GAI.

Using embodiments of the present invention, Retrieval-Augmented Generation (RAG) addresses the preceding limitations of GAI, by providing, to the GAI, structured prompts that includes information configured to assist the GAI to generate correct responses to the prompt without having to retrain the GAI.

RAG obtains data items of text (e.g., documents, emails, etc.) from data sources, divides each data item into text fragments, called chunks. An embedding model converts the chunks into respective vectors of numerical elements, called “embeddings” which are stored in a vector database. Each embedding is a set of vectors corresponding to the chunks of the data item. Each embedding may be referred to as a chunk embedding.

Embedding models are well known in the art and are described in the following two references: (i) “What is Embedding”, retrieved on Aug. 19, 2024 from the Internet: <URL: https://www.ibm.com/topics/embedding>; (ii) “What are Embeddings in Machine Learning?”, retrieved on Aug. 19, 2024 from the Internet: <URL: https://aws.amazon.com/what-is/embeddings-in-machine-learning/#:˜:text=Embedding % 20models%20are%20algorithms%20trained,reason%20with%20 high%2Ddimensional%20data>, the two preceding references being incorporated herein by reference in their entirety.

A similarity between vectors in the vector database can determined by known similarity techniques and algorithms such as cosine similarity.

RAG is one of the most popular use cases for GAI. State of the art techniques for utilizing RAG focus on reporting of issues related to the different components of RAG. However, none of the RAG techniques that exist today help with doing a root cause analysis of an inadequacy of a GAI model. Further, there are drawbacks with using RAG, such as issues with retrieval, issues with chunking, issues due to hallucinations, etc. None of the RAG techniques available today are capable of providing insight into potential root causes that users should focus on. Thus, users have to do trial and error analysis to resolve the issues that plague their RAG application.

Embodiments of the present invention avoid all of these drawbacks via use of novel RAG shapes which will be described infra.

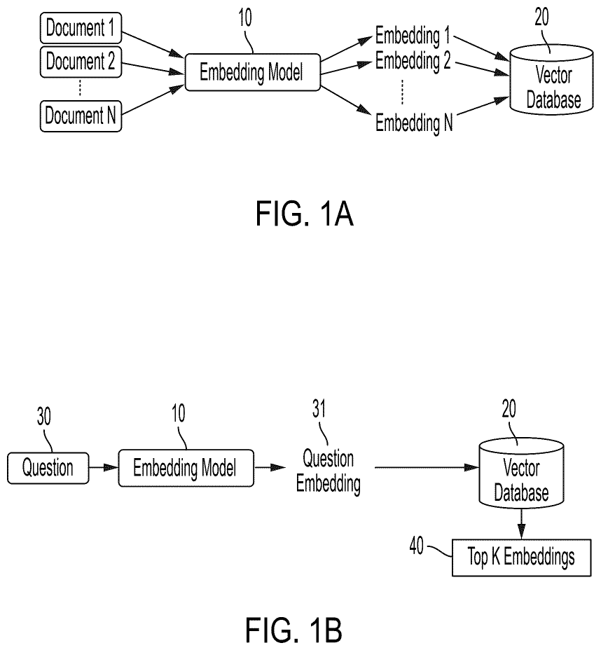

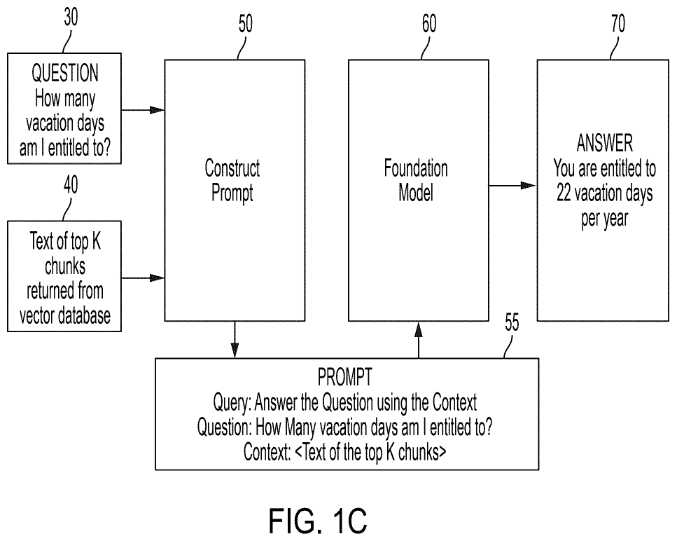

FIGS. 1A, 1B, and 1C depict a RAG procedure for using a foundation model to answer questions, in accordance with embodiments of the present invention. The foundation model uses a set of documents to generate vectors in a vector database. The RAG procedure comprises 3 steps (Step 1, Step 2, Step 3) corresponding to FIG. 1A, FIG. 1B, and FIG. 1C, respectively. In one embodiment, the foundation model is a GAI model.

In FIG. 1A, Step 1 uses an embedding model 10 to generate N embeddings (embedding 1, embedding 2, . . . , embedding N) from respective N documents (document 1, document 2, . . . , document N), followed by storing the N documents and the respective N embeddings (i.e., the N vectors) in a vector database 20, wherein N is at least 1.

In FIG. 1B, Step 2 uses the embedding model 10 to generate a question embedding 31 from a question 30 (e.g., a user question), and a similarity algorithm (e.g., cosine similarity) to determine the top K embeddings 40 in the vector database 20 that are closest to the vector of the question embedding of the question 30, wherein K is at least 2. The K chunks respectively corresponding to the top K embeddings 40 are called the top K chunks.

In one embodiment, the chucks in each document are: the paragraphs in each document, groups of paragraphs in each document, a portion of a paragraph in each document, or combinations thereof.

In FIG. 1C, Step 3 constructs 50 a prompt 55 from the question 30 and the top K chunks. In one embodiment, the prompt 55 includes a Query, a Question, and a Context such as: (i) Query: “Answer the question using the provided context”; (ii) Question: “How many vacation days am I entitled to?”; (iii) Context: Text of the top K chunks (e.g., K=3).

The prompt is inputted to a foundation model 60 which generates an answer 70 to the question, such as: “You are entitled to 22 vacation days per year”. In one embodiment, the foundation model is a GAI based on an LLM (e.g., Chatgpt).

The prompt is needed in order that the foundation model be able to answer the question, because it is assumed that, without the prompt, the foundation model does not have sufficient information to answer the question. The information needed by the foundation model to answer the question is provided by the context, namely text of the K prompts.

An advantage of the preceding procedure is that the foundation model can answer the question without the foundation model having to be updated, since the prompt, which includes the context, is provided to the foundation model as input.

A disadvantage of the preceding procedure is that the procedure can be inadequate or far from optimum for correctly answering the question, because: the contexts may be inadequately formulated, the embedding model being used may not be the best embedding model that can be used; aspects of the chunking procedure (e.g., the chuck size, which determines the number of chunks) may be inadequate; the similarity algorithm for determining the top K chunks may be inadequate or far from optimum; the foundation model may not be the best foundation model that can be used; etc.

The foundation model can be tested based on Q (e.g., Q=100) responses to Q respective prompts that include Q respective questions.

There are known metrics which indicate a degree of correctness or incorrectness of the answers to the questions. Some metrics are specific to each question and are called q-metrics. Other metrics are composite metrics that pertain to the entire group of Q questions collectively and are called c-metrics.

For each question of the Q questions, metric software exists that can generate a question-specific metric (q-metric) which is a measure of correctness of the answer to the question, wherein the answer is provided by the foundation model. The q-metric for the question has a metric score (q-score) which quantifies a degree of correctness of the answer to the question with respect to the metric. Each q-metric has an associated threshold (q-threshold), wherein the answer to the question is correct for the q-metric if the q-score is at least the q-threshold and the answer is incorrect for the q-metric if the q-score is below the q-threshold.

For the set of Q questions the composite metric (c-metric) is a measure of incorrectness of the Q answers collectively. The c-metric for the Q question has a composite score (c-score) which quantifies a degree of incorrectness of the Q answers to the Q questions with respect to the metric.

For a c-metric, the c-score for Q questions contained in Q associated prompts may be calculated as follows. For a given q-threshold of T, C questions each have a q-score less than T, so that C answers to the C respective questions are incorrect, wherein C≤Q. The c-score for the c-metric is computed as C/Q. For example, if the c-score (C/Q) for the Q questions is 0.70, then 70% of the answers to the Q questions are incorrect with respect to the c-metric; i.e., 70% of the answers to the Q questions are below the q-threshold for the metric.

Thus, the c-score is the fraction (C/Q) of the Q answers to the Q questions that are incorrect with respect to the metric (i.e., below the q-threshold), so a c-score of zero means that the Q answers to the Q questions are each correct with respect to the metric (i.e., the Q answers to the Q questions are each at least the q-threshold for the metric).

Methods for calculating the q-metrics and the c-metrics used in embodiments of the present invention are well known in the art and are described in the following three references: (i) “Metrics”, retrieved on Aug. 19, 2024 from the Internet: <URL: https://docs.ragas.io/en/latest/concepts/metrics/index.html>, (ii) “Evaluation Metrics for RAG Systems”, retrieved on Aug. 19, 2024 from the Internet: <URL: https://medium.com/thedeephub/evaluation-metrics-for-rag-systems-5b8aea3b5478>; (iii) “Guide to Metrics and Thresholds for Evaluating RAG and LLM Models”, retrieved on Aug. 19, 2024 from the Internet: <URL: https://www.linkedin.com/pulse/guide-metrics-thresholds-evaluating-rag-llm-models-kevin-amrelle-dswje/>, the three preceding references being incorporated herein by reference in their entirety.

Embodiments of the present invention employ RAG shapes using c-metrics for identifying and resolving root causes of incorrect answers provided by the foundation model.

A “RAG shape” is defined as a planar two-dimensional closed shape characterized by a perimeter that defines an outer boundary of the RAG shape, and a RAG shape can have any geometrical shape in two dimensions, including a regular shape or an irregular shape, consistent with the preceding definition. For example, a regular shape of a RAG circle could be a circle, an ellipse, a rectangle, a square, a triangle, a pentagon, a hexagon, an octagon, etc. Thus, examples of RAG shapes are, inter alia, RAG circles, RAG ellipses, RAG rectangles, RAG squares, RAG pentagons, RAG hexagons, RAG triangles, RAG octagons, etc.

Embodiments of the present invention which are described in terms of RAG circles are applicable to any RAG shape consistent with the definition of “RAG shape”.

In embodiments in which multiple RAG shapes are processed together, each RAG shape of the multiple RAG shapes is a same RAG shape (e.g., each RAG shape of the multiple RAG shapes is a RAG circle).

In other embodiments in which multiple RAG shapes are processed together, the RAG shapes of the multiple RAG shapes may differ from each other (e.g., the multiple RAG shapes may include a RAG circle, a RAG square, and a RAG ellipse).

Each RAG shape is associated with a c-metric and has an area proportional to the c-score of the c-metric. The c-scores in RAG shapes are used in embodiments of the present invention to determine an extent to which the foundation model generates incorrect answers to questions inputted to the foundation model, and if the performance of the foundation model is unacceptable, to find the root cause of the unacceptable performance and to provide insight that may suggest strategies for removing the root cause to eliminate the unacceptable performance of the foundation model.

An exemplary q-metric is answer relevance which has a q-score, for each question, in a range of 0 to 1, where a q-score of 0 denotes that the answer has no relevance to the question, and a score of 1 denotes that the answer has perfect relevance to the question. Thus, an answer relevance below the q-threshold indicates that the answer to the question is incorrect. Answer relevance is also a c-metric which is illustrated for 100 questions in the following example. For a given q-threshold of 0.60 for an individual q-score, 75 questions have an answer relevance of less than 0.60. Therefore, the c-score for the c-metric for answer relevance for the 100 questions is 0.75 (i.e., 75/100).

The metric score for any q-metric may be within a continuous range of values such from 0 to 1 or can have only a binary value such as 0 or 1. In one embodiment, the q-threshold is 1 for metrics having a binary score of 0 or 1.

Another q-metric is context relevance which measures the relevance of each chunk of the question. The text of the chunks provides the context input for each prompt. If the q-score for context relevance is in a range of 0 to 1, a q-score of 0 denotes that the context provided by the prompt has no relevance to the question, and a q-score of 1 denotes that context provided by the prompt has perfect relevance to the question.

Context relevance is also a c-metric characterized by a c-score.

Another metric of importance is faithfulness, also called hallucination, which measures the extent to which the foundation model uses the chunks as reflected in the input context to determine the answer to each question. If the q-scores are in a range of 0 to 1, a q-score of 0 denotes that the foundation model does not use the context at all to determine the answer, and a q-score of 1 denotes that foundation model uses the context totally to determine the answer. Thus, a q-score of 0 indicates that the foundation model is not using the chunk embeddings in the vector database at all to determine the answer.

Context relevance is also a c-metric characterized by a c-score.

There are numerous metrics used in embodiment of the present invention, which include two types of metrics: (i) retrieval quality metrics and (ii) answer quality metrics.

The retrieval quality metrics relate to chunks embeddings fetched from the vector database for and include inter alia: context relevance, precision, mean average precision, recall, F1 score, normalized discounted cumulative gain (NDCG), hit rate, and mean reciprocal rank.

The answer quality metrics relate to the answer generated using the chunk embeddings fetched from the vector database and include inter alia: answer relevance, faithfulness (also called “hallucination”), unanswered questions, and completeness.

The context relevance was discussed supra.

Precision is a q-metric denoting the fraction of the top-K chunk embeddings returned by the vector database that have high context relevance (i.e., the q-score is at least the q-tolerance for precision) for the question. Precision is also a c-metric characterized by a c-score.

Mean average precision is c-metric having a c-score equal to an arithmetic average precision q-score over the Q questions. Mean average precision is also characterized by a c-threshold.

Recall is q-metric whose q-score is the fraction of the relevant chunk embeddings in the vector database that are in the top-K chunk embeddings returned from the vector database for the question. The relevant chunks are the chunks that are relevant to the question in the prompt. Recall is also a c-metric characterized by a c-score.

F1 score is a q-metric equal to harmonic mean of the q-scores of precision and recall; i.e., F1 score=2/(1/precision+1/recall). F1 score is also a c-metric characterized by a c-score.

Normalized discounted cumulative gain (NDCG) is a q-metric that is a measure of the accuracy of the ranking of the K chunks. NDCG being low (i.e., the q-score is less than the q-tolerance for NDCG) means that the vector database is not returning the relevant chunk. embeddings or is returning the relevant chunk embeddings but not in the right order (e.g., the most relevant chunk is ranked very low). NDCG is also a c-metric characterized by a c-score.

Hit rate is a q-metric whose q-score is a binary value of 1 or 0 (1 if at least one chunk in the top K chunks have a context relevance of at least the context relevance threshold; 0 if the top K chunks do not include a chunk having a context relevance of at least the context relevance threshold). Hit rate is also a c-metric characterized by a c-score.

The mean reciprocal rank is a q-metric whose q-score is the reciprocal of the position of the first relevant chunk in the top K chunks. For example, if the position of the first relevant chunk in the top K chunks is 2, then the q-score of the mean reciprocal rank of the first relevant chunk is ½. If the mean reciprocal rank is low (i.e., the q-score is less than the q-tolerance for mean reciprocal rank), then either there is no relevant chunks in the vector database or the ranking of the top K chunks is incorrect which may be due to a problem with the embedding model. Mean reciprocal rank is also a c-metric characterized by a c-score.

The answer relevance was discussed supra.

The faithfulness was discussed supra.

Unanswered questions is a c-metric whose c-score is the fraction of the questions that are not answered by the foundation model. Unanswered questions is also characterized by a c-threshold.

Completeness is a q-metric whose q-score is the fraction of all of the information in the context that is covered in the answer provided by the foundation model. A low completeness value (i.e., the q-score is less than the q-tolerance for completeness) indicates that there is relevant information to the question included in the context that is not included in the foundation model's answer to the question. Completeness is also a c-metric characterized by a c-score.

There is a strong correlation between the metrics discussed supra. For example, if the answer relevance q-score is below the relevance score q-threshold, the issue could be due to a faithfulness difficulty (which means the foundation model is hallucinating) or due to not fetching the correct data from the vector database or something else. So, if a user just tries to focus on answer relevance, the user will not be able to fix the issue. What will help is for the user to understand that a large percent (e.g., 90%) of the answer relevance issue appears to be due to issues with the vector database, and the user should first focus on solving the problem of the vector database.

Further, there can be several issues with a RAG application. For example, one issue could be due to hallucination. Another issue could be due to a wrong number of chunks in the context. Another issue could be due to missing data in the vector database. It is very difficult for the user to analyze and resolve the preceding issues.

In order to resolve the preceding issues, embodiments of the present invention provide a ranked list of issues, expressed as combinations of c-metrics, that may have caused the incorrect answers produced by the foundation model, where the ranked list of issues can be used to determine root cause for each issue on the ranked list.

Embodiments of the present invention use c-metrics (i.e., metrics of an aggregate of answers to Q questions (e.g., 100 questions)) instead of q-metrics of answers to individual questions, because applying the q-metrics to answers to individual questions is inaccurate for identifying a root cause of an inadequacy of the foundation model, since analyzing only the q-metrics for answers to the individual questions fails to look at the big picture to find fundamental reasons why the foundation model is inaccurate. Thus, embodiments of the present analyze the c-metrics to identify the root cause of an inaccuracy of the foundation model.

Furthermore, analyzing only a single c-metric is not likely to correctly identify the root cause of an inaccuracy of the foundation model, because the inaccuracy of the foundation model is typically due to a combination of factors, which are addressed by embodiments of the present invention by analyzing combinations of c-metrics.

Specifically, the present invention uses combinations of RAG shapes to analyze combinations of two c-metrics in some embodiments and to analyze combinations of three c-metrics in other embodiments. The RAG shapes, which provide an efficient mechanism for analyzing combinations of c-metrics will be described and explained infra.

The scope of embodiments of the present invention also includes use of combinations of four of more RAG shapes to analyze combinations of respective four or more c-metrics. Nonetheless, the examples presented infra will focus on combinations of two or three c-metrics for simplicity and ease of understanding.

With use of numerous metrics available, there may be such a large number of combinations of two or three c-metrics for the user to analyze that the analysis effort can be weeks or months and thus too inefficient to be practicable. For example, if there are 12 c-metrics, then there can be 220 RAG shapes that can be formed using the 12 c-metrics. Users cannot look at all of 220 RAG shapes. So, what is needed is a way to find the top c-metrics which users need to focus on. Embodiments of the present invention can analyze all the RAG shapes and provide a ranked list of RAG shapes to the user, based on the impact of each RAG shape on solving the overall problem. In other words, if a majority of the issues are due to answer relevance and completeness, then the RAG shapes representing a combination of relevance and completeness will be ranked at the top of the ranked list.

Accordingly, embodiments of the present invention efficiently use computer implemented methods to identify a ranked list of the top RAG shapes and a ranked list of the top RAG shape combinations. The ranked lists are outputted to a data store and thus becomes accessible to a user and/or to software for subsequent analysis to determine a root cause of an inaccuracy of the foundation model and clues as to how to remove the root cause of the inaccuracy (e.g., by beneficially changing the generation of chunks to generate improved embeddings in the vector database so that the foundation model can generate answers to questions with potentially the highest possible accuracy).

In one embodiment, a single best combination of two or three c-metrics is extracted from the ranked list in the data store and used in a subsequent analysis to determine the root cause, so how to remove the root cause can be limited to analysis of the single best combination.

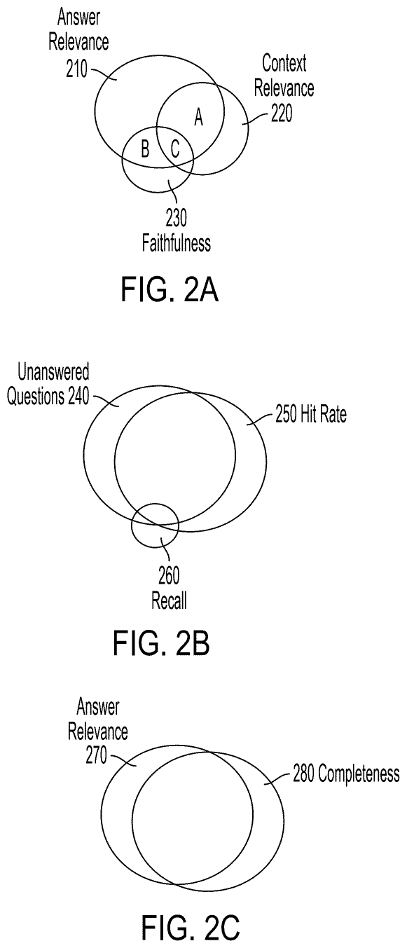

FIGS. 2A, 2B and 2C depict exemplary overlapping RAG shapes, in accordance with embodiments of the present invention. Although the RAG shapes in FIGS. 2A, 2B and 2C are depicted as RAG circles for illustrative purposes, the following description of FIGS. 2A, 2B and 2C is applicable to RAG shapes having any geometrical shape consistent with the definition of “RAG shape”.

FIG. 2A depicts RAG shapes for c-metrics of answer relevance 210, context relevance 220, and faithfulness 230. A combination of three RAG shapes is called a RAG shape triplet. Thus, the combination of RAG shapes 210, 220 and 230 is a RAG shape triplet.

The preceding c-metrics pertain to Q answers to Q respective questions (e.g., Q=100) collectively, where the Q answers are provided by the foundation model.

The idea behind RAG shapes is to represent the questions in the form of a Venn diagram, where there are quality issues associated with the answers to the questions provided by the foundation model, and where the quality issues can be inferred from the c-metrics associated with the RAG shapes.

The area of each RAG shapes is proportional to the c-score of the c-metric of each RAG shape.

The area of overlap (A+C) between answer relevance 210 and context relevance 220 represents the fraction of the Q questions having q-scores for both answer relevance and context relevance below their respective q-thresholds.

There is a large overlap between answer relevance 210 and context relevance 220 which indicates that one of the causes of the foundation model not generating the right answer is because of not fetching the right data from the vector database. There is also a large overlap between answer relevance 210 and faithfulness 230 which indicates that the foundation model is hallucinating (i.e., has low faithfulness) which has led the foundation model to not generate the correct answer.

The area of overlap (B+C) between answer relevance 210 and faithfulness 230 represents the fraction of the Q questions having q-scores for both answer relevance 210 and faithfulness below their respective q-thresholds.

The area of overlap (C) among answer relevance, context relevance, and faithfulness represents the fraction of the Q questions having q-scores for answer relevance 210, context relevance 220, and faithfulness 230 below their respective q-thresholds.

Each area where three RAG shapes overlap represents a number of common questions of the Q questions at which the three metrics respectively associated with the three overlapping RAG shapes are below the respective q-threshold of the three metrics.

For two overlapping RAG shapes which have equal area, the overlap area is half of the area of each RAG shape.

For two overlapping RAG shapes which have unequal area, the overlap area is a fraction of the area of the smaller RAG shape that overlaps the larger RAG shape.

For three overlapping RAG shapes which have equal area, the overlap area is a fraction of the area of any one RAG shape that overlaps the other two RAG shapes.

For three overlapping RAG shapes characterized by a smallest RAG shape whose area is smaller than the area of at least one of the other two RAG shapes, the overlap area is a fraction of the area of the smallest RAG shape that overlaps the other two RAG shapes.

Thus, for RAG shapes 210 and 220 where smaller RAG shape 220 is smaller than RAG shape 210, the overlap area A+C is equal to a fraction of the area of RAG shape 220 that overlaps RAG shape 210.

For RAG shapes 210 and 230 where smaller RAG shape 230 is smaller than RAG shape 230, the overlap area B+C is equal to a fraction of the area of RAG shape 230 that overlaps RAG shape 210.

For RAG shapes 210, 220 and 230 characterized by a smallest RAG shape 230, the overlap area C is equal to a fraction of the area of RAG shape 230 that overlaps both RAG shape 210 and RAG shape 220.

FIG. 2B depicts RAG shapes for c-metrics of unanswered questions 240, low hit rate 250, and recall 260. The combination of RAG shapes 240, 250 and 260 is a RAG shape triplet.

There are a lot of unanswered questions, and the unanswered questions have a large overlap with hit rate. Thus, each unanswered question appears to be due to low hit rate. A low hit rate implies that the chunk embeddings returned by the vector database in the top-K chunks were not relevant to the question, which implies that the vector database does not have the correct information needed for responding to the question. Thus, the recommended RAG Shape is able to quickly help identify the root cause of the problem.

FIG. 2C depicts RAG shapes for c-metrics of answer relevance 270 and completeness 280. A combination of two RAG shapes is called a RAG shape doublet. Thus, the combination of RAG shapes 270 and 280 is a RAG shape doublet.

A large percentage of answer relevance issues are due to completeness, which indicates that the foundation model is not focusing on the correct chunks present in the provided context. Hence, the answer relevance issue may be fixed by either reducing the number of chunks sent to the foundation model or by using a better foundation model which can focus on the correct chunks.

Thus, RAG shapes can help users to quickly uncover the root cause needed for focusing on the right problems and speeding the time for resolving the issue.

Three overlapping RAG shapes is called a RAG shape triplet which is illustrated by overlapping RAG shapes 210, 220 and 230 in FIG. 2A and overlapping RAG shapes 240, 250, and 260 in FIG. 2B.

Two overlapping RAG shapes is called a RAG shape doublet which is illustrated by overlapping RAG shapes 270 and 280 in FIG. 2C.

Generally, S overlapping RAG shapes is called a RAG shape multiplet, wherein S is at least 2. If S=2, then the RAG shape multiplet is a RAG shape doublet. If S=3, then the RAG shape multiplet is a RAG shape triplet.

With use of numerous metrics available, there may be such a large number of combinations of two or three c-metrics for the user to analyze that the analysis effort can be weeks or months and thus too inefficient to be practicable. For example, if there are 12 c-metrics, then there can be 220 RAG shapes that can be formed using the 12 c-metrics. Users cannot look at all of 220 RAG shapes. So, what is needed is a way to find the top c-metrics which users need to focus on. Embodiments of the present invention can analyze all the RAG shapes and provide a ranked list of RAG shapes to the user, based on the impact of each RAG shape on solving the overall problem. In other words, if a majority of the issues are due to answer relevance and completeness, then the RAG shape for relevance and completeness will be ranked at the top of the ranked list.

Embodiments of the present invention find and recommend the top ranked RAG shapes by using a novel and unobvious modified version of the Apriori association rule mining algorithm.

The following description of the conventional Apriori association rule mining algorithm is described in “What is the Apriori algorithm?”, retrieved on Aug. 18, 2018 from the Internet: <URL: https://www.ibm.com/topics/apriori-algorithm>.

The conventional Apriori association rule mining algorithm is an unsupervised machine learning algorithm used for association rule learning. Association rule learning is a data mining technique that identifies frequent patterns, connections and dependencies among different groups of items called itemsets in data. The name, ‘Apriori’ acknowledges the prior knowledge of frequent itemsets that the algorithm uses in computation. The algorithm runs iterations over the data to identify k-itemsets, meaning k items that frequently occur together. The Apriori algorithm then uses the k-itemsets to identify the k+1 itemsets. The Apriori algorithm relies on the insight that adding items to a frequently purchased group can only make the items less frequent, not more frequent. The process relies on the Apriori property that states that if an itemset appears frequently in a dataset, all of the itemset's subsets must also be frequent. Conversely, if an itemset is identified as infrequent, then all the itemset's supersets are considered infrequent. The Apriori algorithm is applicable to all kinds of datasets, especially datasets generated by transactional databases.

Embodiments of the present invention utilize three assertions, namely: Assertion 1, Assertion 2, and Assertion 3.

For Assertion 1, some of the c-metrics may have a strong propensity to overlap with each other, which could be due to one of two reasons: natural correlation and identical insight.

With natural correlation, some c-metrics have a natural strong correlation with each other. Hence, generation of RAG shapes should avoid showing RAG shapes which are strongly correlated to each other, since AG shapes which are strongly correlated to each other do not provide any meaningful information to the user. For example, precision and F1 score are strongly correlated. Thus, outputting or displaying RAG shapes for both precision and F1 score will not provide much value to the user.

With identical insights, some c-metrics provide identical insights to the user. An example is hit rate and NDCG. Hit rate may suggest that there is no good chunk in the top-K chunks, whereas NDCG may suggest that there is something wrong in the top-K chunks. NDCG could be low even if the top ranked chunk is ranked lowest. However, if hit rate is low, then NDCG will also be low. So, hit rate is giving a stronger signal as compared to NDCG.

Within a set of overlapping c-metrics, there is a need to identify the relative priority of the c-metrics. In the preceding example of NDCG and hit rate, hit rate has a higher priority. So, if for two combinations of RAG shapes, namely (1) answer relevance and hit rate and (2) answer relevance and NDCG, the combination of answer relevance and hit rate RAG shapes should be outputted or displayed to the user, which will provide more insights. Further, if the combination of answer relevance and hit rate have been previously outputted or displayed to the user, then the combination of answer relevance and NDCG should not be shown to the user.

Table 1 presents an exemplary list of overlapping c-metrics that are naturally correlated.

TABLE 1

| | Naturally Correlated Overlapping | |
|---|---|---|
| # | c-Metrics | Priority Metric |
| 1 | F1 score and precision | precision if #3 is not ranked in |
| | | top, else F1 score |
| 2 | F1 score and recall | recall if #3 is not ranked in |
| | | top, else F1 score |
| 3 | F1 score and precision and recall | F1 score |
| 4 | precision/mean average precision and | mean average precision |
| | context relevance | |
| 5 | hit rate and NDCG | hit rate |
| 6 | mean reciprocal rank and hit rate | hit rate |
| 7 | mean reciprocal rank and NDCG | mean reciprocal rank |

Thus, each c-metric of a naturally correlated overlapping pair of c-metrics consists of a priority c-metric and a non-priority c-metric. For example in Table 1, the c-metric pair of hit rate and NDCG consists of the priority c-metric of hit rate and the non-priority c-metric of NDCG.

For Assertion 2 when using the modified Apriori algorithm with the precision metric, there is a need to set the precision q-threshold to a high number (e.g., more than 0.40). If the precision value is low, the overlap will be low between the RAG shapes that overlap the precision RAG shape, so there will not be strong insight provided to the user.

For Assertion 3, embodiments of the present invention attempt to show RAG shapes with 3 c-metrics (i.e., RAG shape triplets) wherever possible. If not, RAG shapes are shown with two c-metrics (i.e., RAG shape doublets). RAG shapes with more than 3 c-metrics are more difficult to comprehend than RAG shapes with two or three c-metrics. It is relatively easy to comprehend 2 or 3 RAG shapes (i.e., RAG shape doublets or RAG shape triplets) which have a strong overlap with each other.

Data preparation for using the modified Apriori algorithm includes evaluating a RAG pipeline using test data. Each question in the test data is one transaction. Each q-metric which is below its q-threshold is an item which has been “purchased” for that transaction. These transactions are analyzed to identify questions whose metrics are correlated with each other, or the metrics occur commonly together with high support and confidence.

In embodiments, the modified Apriori algorithm includes a first step, a second step, and a third step for analyzing the metric c-scores.

In the first step, the c-scores corresponding to the c-metrics are sorted in descending order of c-score to generate a first sorted list of c-metrics such that the c-metric having the highest c-score is at the top of the first sorted list of c-metrics. Then the first K1 c-metrics at the top of the first sorted list of c-metrics is retained for usage in the second step, wherein K1 is at least 3. In one embodiment, K1 is input.

In the second step, c-metric pairs, which are formed from the K1 c-metrics outputted by the first step, are sorted in descending order of overlap area of the c-metric pairs to generate a second sorted list of c-metrics pairs (i.e., RAG shape doublets) such that the c-metric pair having the highest overlap area is at the top of the second sorted list of c-metric pairs. Each c-metric pair has a pair c-score, called a doublet score, equal to the overlap area of the c-metric pair. For each c-metric pair, the overlap area is the fraction of the area of the smaller RAG shape that overlaps the larger RAG shape of the c-metric pair. Then the first K2 c-metric pairs at the top of the second sorted list of c-metric pairs is retained for usage in the third step, wherein K2 is at least 2. In one embodiment, K2 is input.

In one embodiment, naturally corelated c-metric pairs, as illustrated in Table 1 discussed supra, are prevented from being in the second sorted list of c-metrics pairs. For example, any naturally correlated c-metric pair that is within the c-metric pairs formed from the K1 c-metrics is deleted before the c-metric pairs formed from the K1 c-metrics are sorted.

The c-metric pair (i.e., the RAG shape doublet) having the highest doublet score (i.e., highest overlap area) is designated as the top RAG shape multiplet. However, this designation may be overridden in the third step by selection of a RAG shape triplet having a highest triplet score as the top RAG shape multiplet if the highest triplet score exceeds the highest doublet score.

The third step adds, to each c-metric pair of the K2 c-metric pairs, a c-metric of the K1 c-metrics for all c-metrics of the K1 c-metrics that are not a c-metric of the c-metric pair, which forms multiple RAG shape triplets. Then a triplet score for each RAG shape triplet is computed. Then, the RAG shape triplet having a highest triplet score is designated as the top RAG shape multiplet (which overrides the selection of the RAG shape doublet having the highest doublet score as the top RAG shape multiplet) if the highest triplet score determined in the third step exceeds the highest doublet score determined in the second step.

The top RAG shape multiplet may be subsequently analyzed to find the root cause of incorrectness of the Q answers to the Q questions.

To calculate the triplet score, consider an example for c-metric pair (i.e., RAG shape doublet) M1-M2 to which c-metric M3 is added to form a RAG shape triplet M1-M2-M3, wherein M1 is larger than M2. The area fraction of M2 overlapping M1 is 0.30. The area fraction of M3 overlapping M1 is 0.15. The area fraction of M3 overlapping M2 is 0.10. In one embodiment, the triplet score is w1*0.30+w2*0.15+w2*0.10, wherein w1>0, w2>0, w3≥0, and w1+w2+w3=1.

In one embodiment, the triplet score is w1*V12+w2*V13+w3*V23, where Vnm is a doublet score equal to an area fraction Mm that overlaps Mn, where Mn is the larger RAG shape of Mn-Mm pair, wherein w1>0, w2>0, w3≥0, and w1+w2+w3=1, and wherein w1, w2, and w3 are weights applied to the doublet scores V12, V13 and V23, respectively.

In one embodiment, the weights w1, w2, and w3 are provided as input.

In one embodiment, the weights w1, w2, and w3 are encoded as constants in a database or in program code that implements embodiments of the present invention.

In one embodiment, the weights w1, w2, and w3 are proportional the c-scores of c-metrics M1, M2, and M3, respectively.

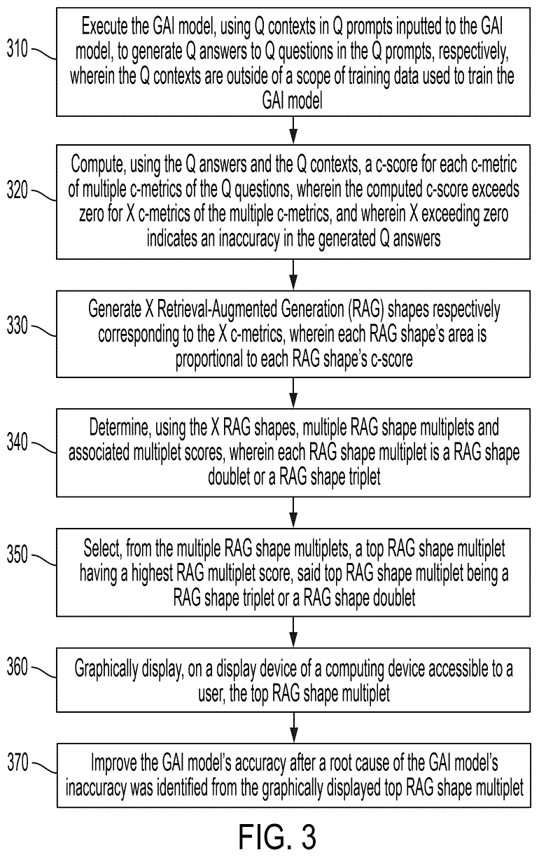

FIG. 3 is a flow chart of a method for improving accuracy of results obtained from use of a generative artificial intelligence (GAI) model, in accordance with embodiments of the present invention. The flow chart of FIG. 3 includes steps 310-370.

Step 310 executes the GAI model, using Q contexts in Q prompts imputed to the GAI model, to generate Q answers to Q questions in the Q prompts, respectively. The Q contexts are outside of a scope of training data used to train the GAI model. Q is at least 2 (e.g., Q=2, 3, 4, 5, . . . , 10, . . . , 50, . . . 100, . . . , 500, etc.).

The GAI model is an embodiment of the foundation model 60 in FIG. 1C, wherein the procedure of FIG. 1C generates an answer to one of the Q questions of step 310 in FIG. 3.

Step 320 computes, using the Q answers and the Q contexts, a c-score for each c-metric of multiple c-metrics of the Q questions. The computed c-score exceeds zero for X c-metrics of the multiple c-metrics. X is at least 4.

X exceeding zero indicates an inaccuracy in the generated Q answers, because a c-score for a c-metric can exceed zero only if the q-score of the q-metric is less than the q-threshold of the q-metric for at least one question of the Q questions. The condition of the q-score of the q-metric being less than the q-threshold of the q-metric is caused by an incorrectness of the answer to the question. In contrast, a c-score of zero is characterized by the q-score of all Q answers to the Q questions being at least the q-threshold of the q-metric, which is indicative of all answers to all Q questions being correct. Thus, each c-metric of the X c-metrics is characterized by at least one at least one question having a q-score less than the q-threshold for the q-metric corresponding to the c-metric, which is indicative of at least one incorrect answer to the Q questions. Accordingly, the accuracy of GAI model can be improved if the magnitude of X can be reduced (e.g., from X=6 to X=3 so that only 3 c-metrics, rather than 6 c-metrics, would be associated with incorrect answers). An ideal improvement in accuracy of the GAI model would be to reduce X to zero so that there would be no c-metric associated with incorrect answers.

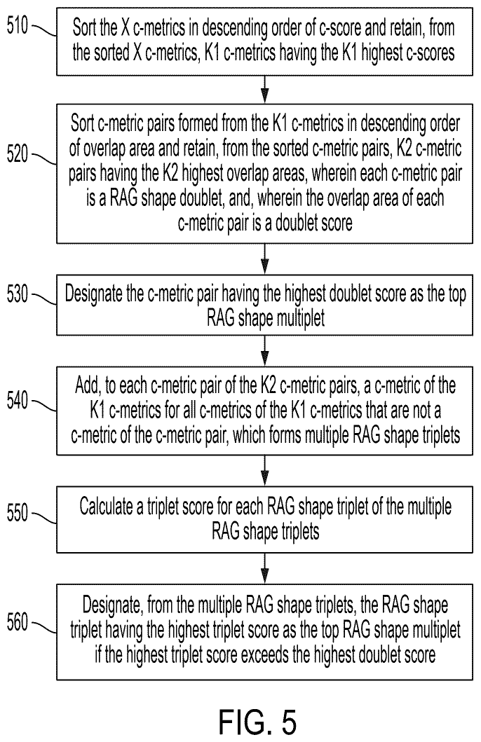

Step 330 generates X RAG shapes respectively corresponding to the X c-metrics. Each RAG shape's area is proportional to each RAG shape's c-score. Step 330 is described in more detail in FIG. 5.

Step 340 determines, using the X RAG shapes, multiple RAG shape multiplets and associated multiplet scores. Each RAG shape multiplet is a RAG shape doublet (e.g., FIG. 2C) or a RAG shape triplet (e.g., FIG. 2A, FIG. 2B).

Step 350 selects, from the multiple RAG shape multiplets, a top RAG shape multiplet having a highest RAG multiplet score. The top RAG shape multiplet is a RAG shape triplet or a RAG shape doublet.

Step 360 graphically displays, on a display device of a computing device accessible to a user, the top RAG shape multiplet.

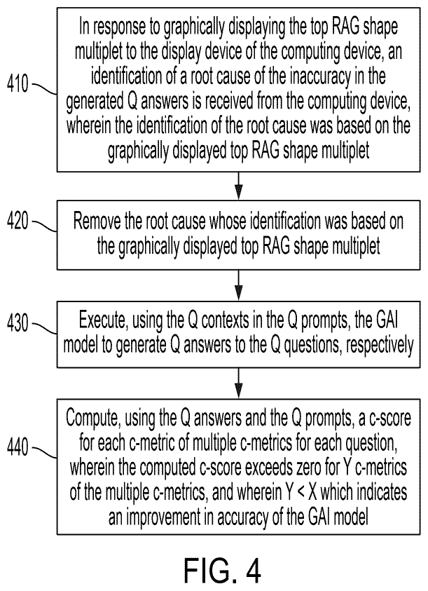

Step 370 improves the GAI model's accuracy after a root cause of the GAI model's inaccuracy was identified from the graphically displayed top RAG shape multiplet. Step 370 is described in more detail in FIG. 4.

FIG. 4 is a flow chart of a process for improving the GAI model's accuracy, in accordance with embodiments of the present invention. The flow chart of FIG. 4, which includes steps 410-440, describes step 370 of FIG. 3 in more detail.

Step 410, in response to having graphically displayed the top RAG shape multiplet to the display device of the computing device, receives from the computing device an identification of a root cause of the inaccuracy in the generated Q answers, wherein the identification of the root cause was based on the graphically displayed top RAG shape multiplet. In this embodiment, the computing device identifies the root cause of the inaccuracy in the generated Q answers from the top RAG shape multiplet graphically displayed on the display device of the computing device.

For example, if the top RAG shape multiplet is a particular RAG triplet comprising overlapping RAG shapes for context relance, hit rate, and precision, which involve both contexts and chunking, the root cause may be identified as pertaining to a problematic relationship between the contexts and the chunking, the details of which would depend on the details of the structure of the particular RAG triplet (e.g., overlapping and non-overlapping area sizes).

In one embodiment, the user connected to the computing device and identifies the root cause from the user's analysis of the graphically displayed top RAG shape multiplet based on analysis of the factors that would or could result in an existence of the top RAG shape multiplet.

In one embodiment, a RAG shape analysis algorithm running on the computing device analyzes the top RAG shape multiplet to identify the root cause based on analysis of the factors that would or could result in an existence of the top RAG shape multiplet.

In one embodiment, instead of step 410 receiving, from the computing device, an identification of the root cause, step 410 would alternatively identify the root cause via analysis of the graphically displayed top RAG shape multiplet based on analysis in step 410 of the factors that would or could result in an existence of the top RAG shape multiplet.

Step 420 removes the root cause whose identification was based on the graphically displayed top RAG shape multiplet. How step 420 is implemented depends on the specific root cause identified in step 410. For example, in the example discussed supra for step 410 (i.e., the root cause pertains a problematic relationship between the contexts and the chunking), the root cause may be removed by disabling the problematic relationship between the contexts and the chunking that underlies the root cause.

Steps 430 and 440 are configured to assess the effect of removing the root cause of the inaccuracy of answers generated by the GAI model.

In step 430 after the root cause was removed, the GAI model is executed, using the Q contexts in the Q prompts, to generate Q answers to the Q questions, respectively.

Step 440 computes, using the Q answers and the Q prompts, a c-score for each c-metric of multiple c-metrics of the Q question, wherein the computed c-score exceeds zero for Y c-metrics of the multiple c-metrics, and wherein Y<X which indicates an improvement in accuracy of the GAI model, since Y<X means that only Y c-metrics, rather than X c-metrics, would be associated with incorrect answers.

FIG. 5 is a flow chart of a process for generating X RAG shapes respectively corresponding to the X c-metrics, in accordance with embodiments of the present invention. The flow chart of FIG. 5, which includes steps 510-560, describes step 330 of FIG. 3 in more detail.

Step 510 sorts the X c-metrics in descending order of c-score and retains, from the sorted X c-metrics, K1 c-metrics having the K1 highest c-scores.

Step 520 sorts c-metric pairs formed from the K1 c-metrics in descending order of overlap area and retains, from the sorted c-metric pairs, K2 c-metric pairs having the K2 highest overlap areas, wherein each c-metric pair is a RAG shape doublet, and wherein the overlap area of each c-metric pair is a doublet score.

Step 530 designates the c-metric pair having the highest doublet score as the top RAG shape multiplet.

Step 540 adds, to each c-metric pair of the K2 c-metric pairs, a c-metric of the K1 c-metrics for all c-metrics of the K1 c-metrics that are not a c-metric of the c-metric pair. Thus, step 540 forms multiple RAG shape triplets.

Step 550 calculates a triplet score for each RAG shape triplet of the multiple RAG shape triplets.

Step 560 designates, from the multiple RAG shape triplets, the RAG shape triplet having the highest triplet score as the top RAG shape multiplet if the highest triplet score exceeds the highest doublet score.

A designation in step 560 of the RAG shape triplet having the highest triplet score as the top RAG shape multiplet overrides step 530 which previously selected the RAG shape doublet having the highest doublet store as the top RAG shape multiplet.

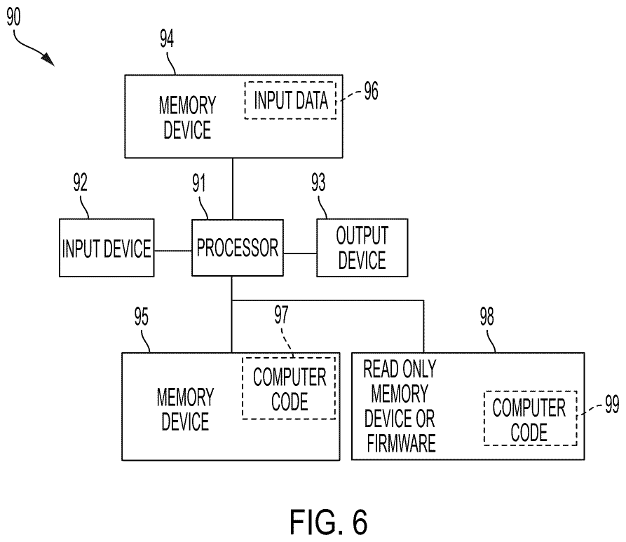

FIG. 6 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 6 shows the computer system 90 as a particular configuration of hardware and software, any configuration of hardware and software, as would be known to a person of ordinary skill in the art, may be utilized for the purposes stated supra in conjunction with the particular computer system 90 of FIG. 6. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

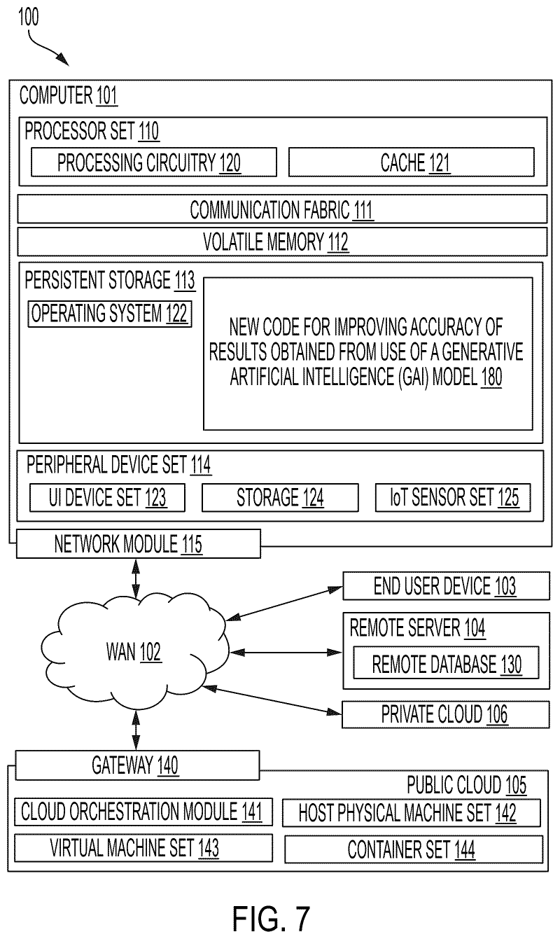

FIG. 7 depicts a computing environment 100 which contains an example of an environment for the execution of at least some of the computer code involved in performing the inventive methods, in accordance with embodiments of the present invention. Such computer code includes new code for improving accuracy of results obtained from use of a generative artificial intelligence (GAI) model 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for improving accuracy of results obtained from use of a generative artificial intelligence (GAI) model, said method comprising:
executing the GAI model, by one or more processors of a computer system using Q contexts in Q prompts inputted to the GAI model, to generate Q answers to Q questions in the Q prompts, respectively, wherein the Q contexts are outside of a scope of training data used to train the GAI model, and wherein Q is at least 2;
computing, by the one or more processors using the Q answers and the Q contexts, a c-score for each c-metric of multiple c-metrics of the Q questions, wherein the computed c-score exceeds zero for X c-metrics of the multiple c-metrics, wherein X is at least 4, and wherein X exceeding zero indicates an inaccuracy in the generated Q answers;
generating, by the one or more processors, X Retrieval-Augmented Generation (RAG) shapes respectively corresponding to the X c-metrics, wherein each RAG shape's area is proportional to each RAG shape's c-score;
determining, by the one or more processors using the X RAG shapes, multiple RAG shape multiplets and associated multiplet scores, wherein each RAG shape multiplet is a RAG shape doublet or a RAG shape triplet;
selecting, by the one or more processors from the multiple RAG shape multiplets, a top RAG shape multiplet having a highest RAG multiplet score, said top RAG shape multiplet being a RAG shape triplet or a RAG shape doublet;
graphically displaying, by the one or more processors on a display device of a computing device accessible to a user, the top RAG shape multiplet; and
improving, by the one or more processors, the GAI model's accuracy after a root cause of the GAI model's inaccuracy was identified from the graphically displayed top RAG shape multiplet.

2. The method of claim 1, wherein said improving the GAI model's accuracy comprises:
in response to said graphically displaying the top RAG shape multiplet to the display device of the computing device, receiving from the computing device an identification of a root cause of the inaccuracy in the generated Q answers, wherein the identification of the root cause was based on the graphically displayed top RAG shape multiplet; and
removing the root cause whose identification was based on the graphically displayed top RAG shape multiplet.

3. The method of claim 2, wherein said improving the GAI model's accuracy further comprises after said removing the root cause:
executing, using the Q contexts in the Q prompts, the GAI model to generate Q answers to the Q questions, respectively; and
computing, using the Q answers and the Q prompts, a c-score for each c-metric of multiple c-metrics of the Q question, wherein the computed c-score exceeds zero for Y c-metrics of the multiple c-metrics, and wherein Y<X which indicates an improvement in accuracy of the GAI model.

4. The method of claim 1, wherein said determining multiple RAG shape multiplets and associated multiplet scores comprises:
sorting the X c-metrics in descending order of c-score and retaining, from the sorted X c-metrics, K1 c-metrics having the K1 highest c-scores, wherein K1 is at least 3;
sorting c-metric pairs formed from the K1 c-metrics in descending order of overlap area and retaining, from the sorted c-metric pairs, K2 c-metric pairs having the K2 highest overlap areas, wherein K2 is at least 2, wherein each c-metric pair is a RAG shape doublet, and wherein the overlap area of each c-metric pair is a doublet score; and
designating the c-metric pair having the highest doublet score as the top RAG shape multiplet.

5. The method of claim 4, said method further comprising:
adding, to each c-metric pair of the K2 c-metric pairs, a c-metric of the K1 c-metrics for all c-metrics of the K1 c-metrics that are not a c-metric of the c-metric pair, which forms multiple RAG shape triplets;
calculating a triplet score for each RAG shape triplet of the multiple RAG shape triplets; and
designating, from the multiple RAG shape triplets, the RAG shape triplet having the highest triplet score as the top RAG shape multiplet if the highest triplet score exceeds the highest doublet score.

6. The method of claim 4, wherein the c-metric pairs formed from the K1 c-metrics include a naturally correlated c-metric pair, and wherein prior to said sorting the c-metric pairs formed from the K1 c-metrics, the method comprises:
deleting, by the one or more processors, the naturally correlated c-metric pair from the c-metric pairs formed from the K1 c-metrics.

7. The method of claim 1, wherein the top RAG shape multiplet is a RAG shape triplet.

8. The method of claim 1, wherein each RAG shape is selected from the group consisting of a RAG circle, a RAG ellipse, a RAG rectangle, a RAG square, a RAG pentagon, a RAG hexagon, a RAG triangle, and a RAG octagon.

9. A computer program product, comprising one or more computer readable hardware storage devices having computer readable program code stored therein, said program code containing instructions executable by one or more processors of a computer system to implement a method for improving accuracy of results obtained from use of a generative artificial intelligence (GAI) model, said method comprising:
executing the GAI model, by the one or more processors using Q contexts in Q prompts inputted to the GAI model, to generate Q answers to Q questions in the Q prompts, respectively, wherein the Q contexts are outside of a scope of training data used to train the GAI model, and wherein Q is at least 2;
computing, by the one or more processors using the Q answers and the Q contexts, a c-score for each c-metric of multiple c-metrics of the Q questions, wherein the computed c-score exceeds zero for X c-metrics of the multiple c-metrics, wherein X is at least 4, and wherein X exceeding zero indicates an inaccuracy in the generated Q answers;
generating, by the one or more processors, X Retrieval-Augmented Generation (RAG) shapes respectively corresponding to the X c-metrics, wherein each RAG shape's area is proportional to each RAG shape's c-score;
determining, by the one or more processors using the X RAG shapes, multiple RAG shape multiplets and associated multiplet scores, wherein each RAG shape multiplet is a RAG shape doublet or a RAG shape triplet;
selecting, by the one or more processors from the multiple RAG shape multiplets, a top RAG shape multiplet having a highest RAG multiplet score, said top RAG shape multiplet being a RAG shape triplet or a RAG shape doublet;
graphically displaying, by the one or more processors on a display device of a computing device accessible to a user, the top RAG shape multiplet; and
improving, by the one or more processors, the GAI model's accuracy after a root cause of the GAI model's inaccuracy was identified from the graphically displayed top RAG shape multiplet.

10. The computer program product of claim 9, wherein said improving the GAI model's accuracy comprises:
in response to said graphically displaying the top RAG shape multiplet to the display device of the computing device, receiving from the computing device an identification of a root cause of the inaccuracy in the generated Q answers, wherein the identification of the root cause was based on the graphically displayed top RAG shape multiplet; and
removing the root cause whose identification was based on the graphically displayed top RAG shape multiplet.

11. The computer program product of claim 10, wherein said improving the GAI model's accuracy further comprises after said removing the root cause:
executing, using the Q contexts in the Q prompts, the GAI model to generate Q answers to the Q questions, respectively; and
computing, using the Q answers and the Q prompts, a c-score for each c-metric of multiple c-metrics of the Q question, wherein the computed c-score exceeds zero for Y c-metrics of the multiple c-metrics, and wherein Y<X which indicates an improvement in accuracy of the GAI model.

12. The computer program product of claim 9, wherein said determining multiple RAG shape multiplets and associated multiplet scores comprises:
sorting the X c-metrics in descending order of c-score and retaining, from the sorted X c-metrics, K1 c-metrics having the K1 highest c-scores, wherein K1 is at least 3;
sorting c-metric pairs formed from the K1 c-metrics in descending order of overlap area and retaining, from the sorted c-metric pairs, K2 c-metric pairs having the K2 highest overlap areas, wherein K2 is at least 2, wherein each c-metric pair is a RAG shape doublet, and wherein the overlap area of each c-metric pair is a doublet score; and
designating the c-metric pair having the highest doublet score as the top RAG shape multiplet.

13. The computer program product of claim 12, said method further comprising:
adding, to each c-metric pair of the K2 c-metric pairs, a c-metric of the K1 c-metrics for all c-metrics of the K1 c-metrics that are not a c-metric of the c-metric pair, which forms multiple RAG shape triplets;
calculating a triplet score for each RAG shape triplet of the multiple RAG shape triplets; and
designating, from the multiple RAG shape triplets, the RAG shape triplet having the highest triplet score as the top RAG shape multiplet if the highest triplet score exceeds the highest doublet score.

14. The computer program product of claim 12, wherein the c-metric pairs formed from the K1 c-metrics include a naturally correlated c-metric pair, and wherein prior to said sorting the c-metric pairs formed from the K1 c-metrics, the method comprises:
deleting, by the one or more processors, the naturally correlated c-metric pair from the c-metric pairs formed from the K1 c-metrics.

15. A computer system, comprising one or more processors, one or more memories, and one or more computer readable hardware storage devices, said one or more hardware storage devices containing program code executable by the one or more processors via the one or more memories to implement a method for improving accuracy of results obtained from use of a generative artificial intelligence (GAI) model, said method comprising:
executing the GAI model, by the one or more processors using Q contexts in Q prompts inputted to the GAI model, to generate Q answers to Q questions in the Q prompts, respectively, wherein the Q contexts are outside of a scope of training data used to train the GAI model, and wherein Q is at least 2;
computing, by the one or more processors using the Q answers and the Q contexts, a c-score for each c-metric of multiple c-metrics of the Q questions, wherein the computed c-score exceeds zero for X c-metrics of the multiple c-metrics, wherein X is at least 4, and wherein X exceeding zero indicates an inaccuracy in the generated Q answers;
generating, by the one or more processors, X Retrieval-Augmented Generation (RAG) shapes respectively corresponding to the X c-metrics, wherein each RAG shape's area is proportional to each RAG shape's c-score;
determining, by the one or more processors using the X RAG shapes, multiple RAG shape multiplets and associated multiplet scores, wherein each RAG shape multiplet is a RAG shape doublet or a RAG shape triplet;
selecting, by the one or more processors from the multiple RAG shape multiplets, a top RAG shape multiplet having a highest RAG multiplet score, said top RAG shape multiplet being a RAG shape triplet or a RAG shape doublet;
graphically displaying, by the one or more processors on a display device of a computing device accessible to a user, the top RAG shape multiplet; and
improving, by the one or more processors, the GAI model's accuracy after a root cause of the GAI model's inaccuracy was identified from the graphically displayed top RAG shape multiplet.

16. The computer system of claim 15, wherein said improving the GAI model's accuracy comprises:
in response to said graphically displaying the top RAG shape multiplet to the display device of the computing device, receiving from the computing device an identification of a root cause of the inaccuracy in the generated Q answers, wherein the identification of the root cause was based on the graphically displayed top RAG shape multiplet; and
removing the root cause whose identification was based on the graphically displayed top RAG shape multiplet.

17. The computer system of claim 16, wherein said improving the GAI model's accuracy further comprises after said removing the root cause:
executing, using the Q contexts in the Q prompts, the GAI model to generate Q answers to the Q questions, respectively; and
computing, using the Q answers and the Q prompts, a c-score for each c-metric of multiple c-metrics of the Q question, wherein the computed c-score exceeds zero for Y c-metrics of the multiple c-metrics, and wherein Y<X which indicates an improvement in accuracy of the GAI model.

18. The computer system of claim 15, wherein said determining multiple RAG shape multiplets and associated multiplet scores comprises:
sorting the X c-metrics in descending order of c-score and retaining, from the sorted X c-metrics, K1 c-metrics having the K1 highest c-scores, wherein K1 is at least 3;
sorting c-metric pairs formed from the K1 c-metrics in descending order of overlap area and retaining, from the sorted c-metric pairs, K2 c-metric pairs having the K2 highest overlap areas, wherein K2 is at least 2, wherein each c-metric pair is a RAG shape doublet, and wherein the overlap area of each c-metric pair is a doublet score; and
designating the c-metric pair having the highest doublet score as the top RAG shape multiplet.

19. The computer system of claim 18, said method further comprising:
adding, to each c-metric pair of the K2 c-metric pairs, a c-metric of the K1 c-metrics for all c-metrics of the K1 c-metrics that are not a c-metric of the c-metric pair, which forms multiple RAG shape triplets;
calculating a triplet score for each RAG shape triplet of the multiple RAG shape triplets; and
designating, from the multiple RAG shape triplets, the RAG shape triplet having the highest triplet score as the top RAG shape multiplet if the highest triplet score exceeds the highest doublet score.

20. The computer system of claim 18, wherein the c-metric pairs formed from the K1 c-metrics include a naturally correlated c-metric pair, and wherein prior to said sorting the c-metric pairs formed from the K1 c-metrics, the method comprises:
deleting, by the one or more processors, the naturally correlated c-metric pair from the c-metric pairs formed from the K1 c-metrics.
